(19) United States
(12) Patent Application Publication
(10) Pub. No.: US 2026/0149694 A1
(43) Pub. Date: May 28, 2026

(54) METHODS, SYSTEMS, AND COMPUTER READABLE MEDIA FOR ENHANCED SECURITY EDGE PROTECTION PROXY (SEPP) FIREWALL FILTERING FOR HEALTH CHECK MESSAGES

(71) Applicant: Oracle International Corporation, Redwood Shores, CA (US)

(72) Inventors: Vijeta Mahajan, Delhi (IN); John Nirmal Mohan Raj, Bangalore (IN); Ashish Jyoti Sharma, New Delhi (IN)

(21) Appl. No.: 18/962,965

(22) Filed: Nov. 27, 2024

(51) Int. Cl. H04L 9/40

(52) U.S. Cl. CPC H04L 63/0245; H04L 63/166

(57) ABSTRACT

A method for enhanced SEPP firewall filtering for health check messages includes performing an N32-c security capability exchange with at least one remote SEPP to establish security parameters for communicating with the at least one remote SEPP over an N32-f interface. The method further includes maintaining N32-f context information for the at least one remote SEPP with which an N32-c security capability exchange has been successfully completed. The method further incudes receiving a health check message and accessing the N32-f context information to determine whether an originator of the health check message corresponds to a SEPP with which an N32-c security capability exchange has been successfully completed. The method further includes performing a network security action when the SEPP determines that the health check message does not correspond to a SEPP with which an N32-c security capability exchange has been successfully completed.

### TECHNICAL FIELD

The subject matter described herein relates to network security. More particularly, the subject matter described herein relates to methods, systems, and computer readable media for enhanced SEPP firewall filtering for health check messages.

### BACKGROUND

In 5G telecommunications networks, a network function that provides service is referred to as a producer network function (NF) or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF service instance is a service instance of a producer NF that provides one or more services. A given producer NF may include more than one NF service instance. It should also be noted that multiple NF service instances can share the same service endpoint.

NFs register with an NF repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the types of services provided by an NF instance as well as contact and capacity information regarding the NF instance.

Service communication proxies (SCPs) route messages between NF instances. An SCP can also invoke the NF discovery service operation to learn about available NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instance.

Security edge protection proxies (SEPPs) are typically deployed at the network edge and are used to screen messages coming into and out of a network. A SEPP located at the edge of one network communicates with a SEPP located at the edge of another network via an interface referred to as the N32 interface. Communications over the N32 interface are protected using transport layer security (TLS). However, relying on TLS alone for protecting messages, including health check messages, between SEPPs can leave the N32 interface vulnerable to security attacks, such as a man-in-the-middle attack in which a malicious actor impersonates a SEPP sends forged messages to a real SEPP over the N32 interface.

Accordingly, in light of these and other difficulties, there exists a need for improved methods, systems, and computer readable media for securing communications between SEPPs.

### SUMMARY

A method for enhanced security edge protection proxy (SEPP) firewall filtering for health check messages includes performing, by a SEPP, an N32-c security capability exchange with at least one remote SEPP to establish security parameters for communicating with the at least one remote SEPP over an N32-f interface. The method further includes maintaining, by the SEPP, N32-f context information for the at least one remote SEPP with which an N32-c security capability exchange has been successfully completed. The method further includes receiving, by the SEPP, a health check message. The method further includes accessing, by the SEPP, the N32-f context information to determine whether an originator of the health check message corresponds to a SEPP with which an N32-c security capability exchange has been successfully completed. The method further includes performing, by the SEPP, a network security action when the SEPP determines that the health check message does not correspond to a SEPP with which an N32-c security capability exchange has been successfully completed.

According to another aspect of the subject matter described herein, performing the N32-c security capability exchange includes obtaining a fully qualified domain name (FQDN) of the at least one remote SEPP.

According to another aspect of the subject matter described herein, storing the N32-f context information includes storing the FQDN of the at least one remote SEPP in an N32-f context database maintained by the SEPP.

According to another aspect of the subject matter described herein, receiving a health check message includes receiving a health check message including a transport layer security (TLS) certificate.

According to another aspect of the subject matter described herein, accessing the N32-f context information includes accessing the N32-f context information using sender identification information obtained from the TLS certificate.

According to another aspect of the subject matter described herein, accessing the N32-f context information using the sender identification information obtained from the TLS certificate includes accessing the N32-f context information using a fully qualified domain name (FQDN) obtained from a subject alternative name (SAN) field of the TLS certificate.

According to another aspect of the subject matter described herein, performing the network security action includes performing the network security action when the FQDN obtained from the SAN field of the TLS certificate does not match an FQDN of a remote SEPP with which an N32-c security capability exchange has been successfully completed.

According to another aspect of the subject matter described herein, the method for enhanced SEPP firewall filtering for health check messages comprises, when the SEPP determines that the health check message corresponds to a remote SEPP with which an N32-c security capability exchange has been successfully completed, responding to the health check message.

According to another aspect of the subject matter described herein, performing the network security action includes discarding the health check message.

According to another aspect of the subject matter described herein, performing the network security action includes alerting a network operator of receipt of a health check message from a suspicious network entity.

According to another aspect of the subject matter described herein, a system for enhanced security edge protection proxy (SEPP) firewall filtering for health check messages is provided. The system includes a SEPP including at least one processor and a memory for performing an N32-c security capability exchange with at least one remote SEPP to establish security parameters for communicating with the at least one remote SEPP over an N32-f interface and maintaining N32-f context information for the at least one remote SEPP with which an N32-c security capability exchange has been successfully completed. The system further includes a health check message verifier implemented by the at least one processor for receiving a health check message, accessing the N32-f context information to determine whether an originator of the health check message corresponds to a SEPP with which an N32-c security capability exchange has been successfully completed, and performing a network security action when the health check message verifier determines that the health check message does not correspond to a SEPP with which an N32-c security capability exchange has been successfully completed.

According to another aspect of the subject matter described herein, the SEPP is configured to obtain, while performing the N32-c security capability exchange, a fully qualified domain name (FQDN) of the at least one remote SEPP.

According to another aspect of the subject matter described herein, the SEPP is configured to store the FQDN of the at least one remote SEPP in an N32-f context database maintained by the SEPP.

According to another aspect of the subject matter described herein, the health check message includes a transport layer security (TLS) certificate.

According to another aspect of the subject matter described herein, the health check message verifier is configured to access the N32-f context information using sender identification information obtained from the TLS certificate.

According to another aspect of the subject matter described herein, the sender identification information includes a fully qualified domain name (FQDN) obtained from a subject alternative name (SAN) field of the TLS certificate.

According to another aspect of the subject matter described herein, the health check message verifier is configured to perform the network security action when the FQDN obtained from the SAN field of the TLS certificate does not match an FQDN of a remote SEPP with which an N32-c security capability exchange has been successfully completed.

According to another aspect of the subject matter described herein, the health check message verifier is configured to, when the health check message verifier determines that the health check message corresponds to a remote SEPP with which an N32-c security capability exchange has been successfully completed, respond to the health check message.

According to another aspect of the subject matter described herein, the network security action includes discarding the health check message or alerting a network operator of receipt of a health check message from a suspicious network entity.

According to another aspect of the subject matter described herein, a non-transitory computer readable medium having stored thereon executable instructions that when executed by a processor of a computer control the computer to perform steps is provided. The steps include performing, by a security edge protection proxy (SEPP), an N32-c security capability exchange with at least one remote SEPP to establish security parameters for communicating with the at least one remote SEPP over an N32-f interface. The steps further include maintaining, by the SEPP, N32-f context information for the at least one remote SEPP with which an N32-c security capability exchange has been successfully completed. The steps further include receiving, by the SEPP, a health check message. The steps further include accessing, by the SEPP, the N32-f context information to determine whether an originator of the health check message corresponds to a SEPP with which an N32-c security capability exchange has been successfully completed. The steps further include performing, by the SEPP, a network security action when the SEPP determines that the health check message does not correspond to a SEPP with which an N32-c security capability exchange has been successfully completed.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer-readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a message flow diagram illustrating exemplary messages exchanged in an N32-c security capability exchange procedure and a health check procedure in which a malicious network entity impersonates a remote SEPP;

FIG. 3 is a message flow diagram illustrating exemplary messages exchanged in an N32-c security capability exchange procedure and a health check procedure in which a SEPP implements security measures to identify a health check message as being from a malicious network entity and performs a network security action;

FIG. 4 is a block diagram illustrating an exemplary architecture for a SEPP for performing enhanced firewall filtering for health check messages; and

FIG. 5 is a flow chart illustrating an exemplary process for enhanced SEPP firewall filtering for health check messages.

### DETAILED DESCRIPTION

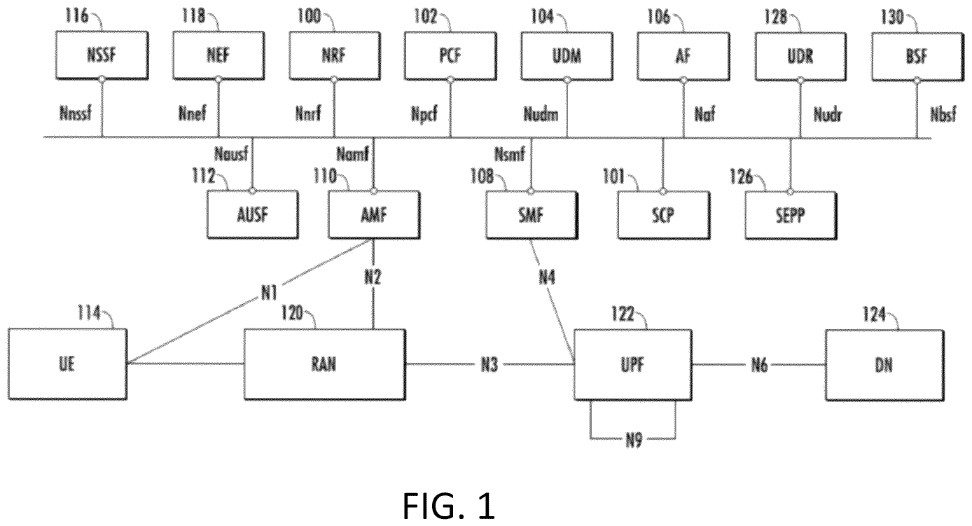

FIG. 1 is a network diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the types of services provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a policy control function (PCF) 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 provides authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

A SEPP 126 filters incoming traffic from another PLMN and can perform topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. A SEPP filtering egress messages from consumer NFs in a PLMN is referred to as a consumer SEPP or C-SEPP. A SEPP that filters ingress messages directed to producer NFs in a PLMN is referred to as a producer SEPP or P-SEPP. A given SEPP can function as a C-SEPP and a P-SEPP, depending on the role the SEPP is performing.

A unified data repository (UDR) 128 stores subscription data for UEs. A binding support function (BSF) 130 manages bindings between PDU sessions and PCFs.

As stated above, one issue in 5G, previous generation, and subsequent generation networks is the lack of sufficient security measures for health check messages exchanged between SEPPs over the N32 interface. In the 5G network architecture, the SEPP operates at the network edge, handling both service-based interface (SBI) and non-SBI messages from SEPPs across different networks. A significant security vulnerability arises when SEPPs communicate over the N32 forwarding (N32-f) interface, as there is no existing mechanism to verify the authenticity of health check messages exchanged between SEPPs. This gap can be exploited by malicious entities performing man-in-the-middle (MITM) attacks by sending forged health check messages that bypass security protocols and potentially gain unauthorized access to SEPP functionalities. Such unauthenticated health check messages can disrupt SEPP operations, causing network instability and potential downtime. To address this critical security issue and mitigate the risk of MITM attacks, the subject matter described herein involves enhancing the firewall capabilities of SEPPs specifically for health check messages.

There is no standard mechanism defined by 3GPP to ascertain the status of a remote SEPP. While health check procedures are defined between NRFs and other NFs (e.g., NRF heartbeat, NRF health check), no such defined mechanism exists for SEPPs to determine the health status of a remote SEPP. In such situations, SEPP vendors are free to implement health check pings between SEPPs. However, as will now be explained in more detail, a malicious network entity can exploit health check procedures implemented between SEPPs to gain information from a responding SEPP without authorization.

When SEPPs communicate over the N32-f interface, there is no mechanism on the SEPP to validate whether the health check message is from an authenticated remote SEPP. The responding SEPP, upon receiving a health check message from a remote SEPP, can respond with a 2xx/3xx/4xx response message (depending on the implementation). The implicit assumption is that N32-f interface is TLS protected and that the health check message is from an authenticated SEPP. This assumption can lead to successful man-in-the-middle (MITM) attacks, and malicious entities could send forged health check messages, bypassing security mechanisms and gaining unauthorized access to SEPP functionalities. Unauthenticated health check messages could cause disruptions in SEPP operations, leading to network instability and potential downtime. The lack of robust authentication mechanisms makes the network more susceptible to various types of cyberattacks, including spoofing and replay attacks. Even though the N32-f interface may be TLS protected, relying solely on this protection without additional validation mechanisms leaves a vulnerability where an attacker could potentially intercept and manipulate the communication. Proper authentication methods are needed to ensure that health check messages are indeed from legitimate SEPPs.

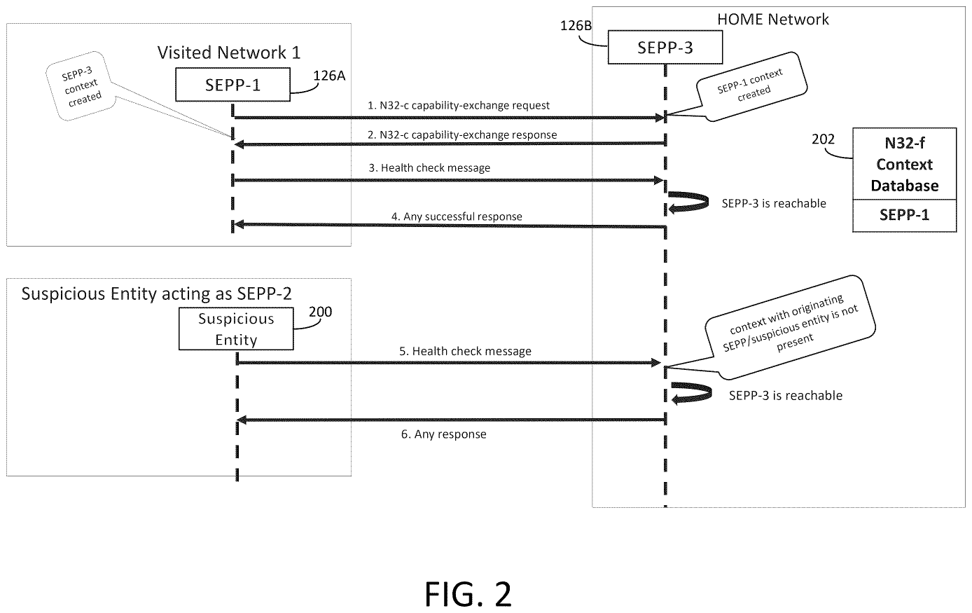

FIG. 2 is a message flow diagram illustrating exemplary messages exchanged in an N32 control (N32-c) security capability exchange procedure and a health check procedure in which a malicious network entity impersonates a remote SEPP. Referring to FIG. 2, in step 1, a SEPP 126A initiates an N32-c security capability exchange handshake procedure by sending an N32-c security capability exchange request message to SEPP 126B. SEPP 126B receives the N32-c security capability exchange request and creates a security context for SEPP 126A. In step 2, SEPP 126B sends an N32-c security capability exchange response message to SEPP 126A. The N32-c security capability exchange response message contains the security parameters that SEPP 126B agrees to for the exchange of messages over an N32-f connection with SEPP 126A. SEPP 126B stores N32-f security context information for communicating with SEPP 126A in N32-f context database 202. After the successful completion of the N32-c security capability exchange procedure, SEPPs 126A and 126B exchange messages over the N32-f interface using the security mechanisms agreed upon in the security capability exchange procedure.

One type of message that can be exchanged over the N32-f interface is a health check message. In step 3, SEPP 126A sends a health check message to SEPP 126B. SEPP 126B receives the health check message and, in step 4, transmits a health check response message to SEPP 126A. SEPP 126A receives the health check response message and marks SEPP 126B as reachable.

A problem with the health check procedure is indicated by step 5 where a malicious/suspicious network entity 200 sends a forged health check request message to SEPP 126B. SEPP 126B does not perform any checking of whether the health check message corresponds to a SEPP for which an N32-f context exists. Accordingly, in step 6, SEPP 126B responds to the health check response message. Malicious/suspicious network entity 200 receives the health check response message and obtains information about SEPP 126B from the health check response message without authorization.

To reduce the likelihood of successful man-in-the-middle attack and other types of security attacks, a SEPP may implement context verification for health check request messages received by the SEPP before responding to a health check request message. According to the subject matter described herein, firewall functionality of SEPPs may be enhanced for health check messages. Upon receiving a health check message from a remote SEPP, the FQDN of the sending entity should be extracted from the subject alternative name (SAN) field from the accompanying TLS certificate. The FQDN contained within the SAN may then be cross-referenced against a list of remote FQDNs that have previously established a successful N32-c handshake.

If the FQDN extracted from the SAN field does not correspond to an FQDN of a SEPP with a verified N32-c handshake, the health check message may be rejected and discarded. Conversely, if the FQDN matches the FQDN of a SEPP with a successful prior N32-c handshake, a success response may be returned to the originating SEPP. Implementing this solution will significantly improve the security of SEPP communications over the N32-f interface, ensuring that only authenticated health check messages are processed. This enhancement addresses a network vulnerability and provides robust protection against potential MITM attacks.

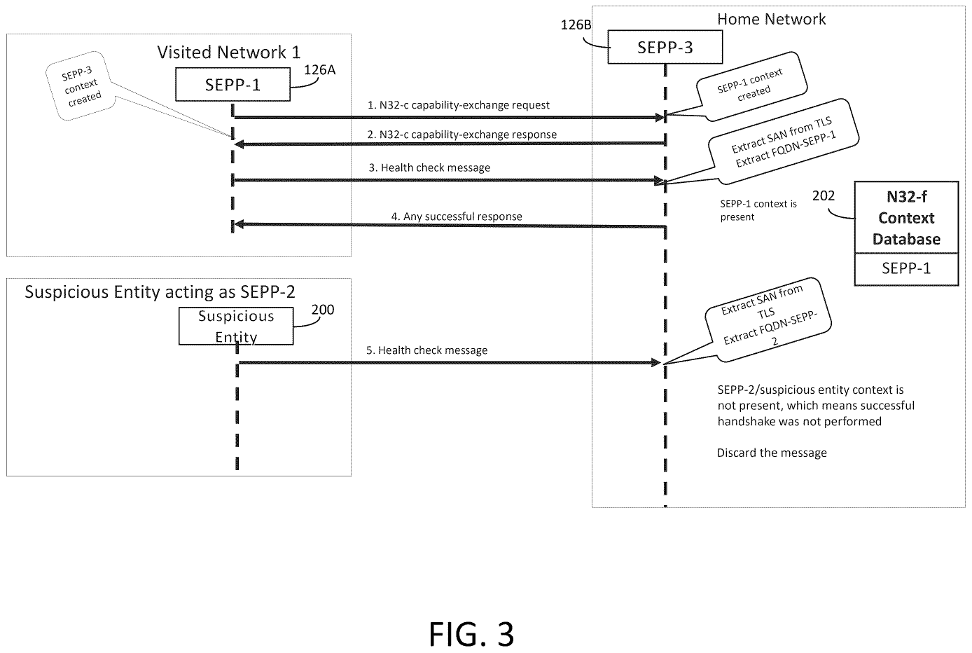

FIG. 3 is a message flow diagram illustrating exemplary messages exchanged in an N32-c security capability exchange procedure and a health check procedure in which a SEPP implements security measures to identify a health check message as being from a malicious network entity and performs a network security action. Referring to FIG. 3, in step 1, SEPP 126A initiates an N32-c security capability exchange handshake procedure by sending an N32-c security capability exchange request message to SEPP 126B. SEPP 126B receives the N32-c security capability exchange request message and creates a security context for SEPP 126A. In step 2, SEPP 126B sends an N32-c security capability exchange response message to SEPP 126A. The N32-c security capability exchange response message contains the security parameters that SEPP 126B agrees to for the exchange of messages over an N32-f connection with SEPP 126A. SEPP 126B stores N32-f security context information for communicating with SEPP 126A in N32-f context database 202. The N32-f context information includes the FQDN of SEPP 126A. After the successful completion of the N32-c security capability exchange procedure, SEPPs 126A and 126B exchange messages over the N32-f interface using the security mechanisms agreed upon in the security capability exchange procedure.

In step 3, SEPP 126A sends a health check request message to SEPP 126B. SEPP 126B receives the health check message, reads originating-entity identifying information from the health check request message and checks whether an originator of the health check message corresponds to a SEPP with which an N32-c security capability exchange has been successfully completed. In one example, SEPP 126B performs this check by reading a fully qualified domain name from a subject alternative name field of a TLS certificate transmitted with the health check request message and uses the FQDN to perform a lookup in N32-f context database 202. If the FQDN matches the FQDN of a remote SEPP in a record in N32-f context database 202 corresponding to an existing N32-f context, SEPP 126B may determine that the health check request is not from a malicious entity and may process the health check request an send a health check response to the originating entity. In step 4, SEPP 126B finds an existing N32-f context for SEPP 126A, processes the health check request, and transmits a health check response message to SEPP 126A. SEPP 126A receives the health check response message and marks SEPP 126B as reachable.

In step 5, malicious/suspicious network entity 200 sends a forged health check request message to SEPP 126B. SEPP 126B extracts originating-entity identifying information from the health check request message and checks whether an originator of the health check message corresponds to a SEPP with which an N32-c security capability exchange has been successfully completed. In one example, SEPP 126B performs this check by reading a fully qualified domain name from a subject alternative name field of a TLS certificate transmitted with the health check request message and uses the FQDN to perform a lookup in N32-f context database 202. In the example illustrated in step 5, it is assumed that SEPP 126B does not locate a record in N32-f context database 202 for the FQDN in the SAN field of the TLS certificate carried with the health check request message. Accordingly, in step 6, SEPP 126B performs a network security action, which, in FIG. 3, includes discarding the health check request message. In an alternate example, the network security action performed by SEPP 126B may include SEPP 126B transmitting a message to a network operator informing the network operator of the health check request message transmitted by malicious entity 200.

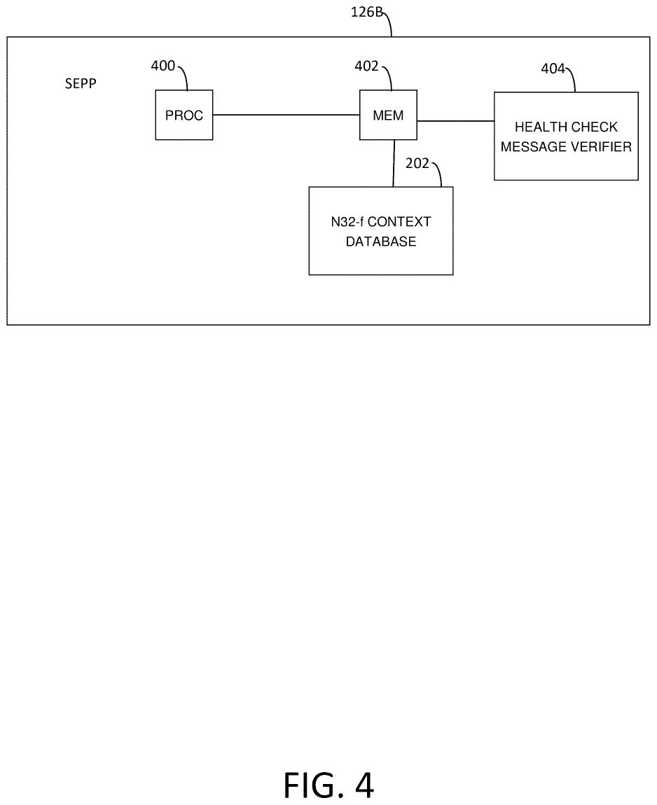

FIG. 4 is a block diagram illustrating an exemplary architecture for a SEPP for performing enhanced firewall filtering for health check messages. Referring to FIG. 4, SEPP 126B includes at least one processor 400 and memory 402. SEPP 126B includes a health check message verifier 404 that performs the steps described herein for verifying health check request messages received from other entities. SEPP 126B also includes N32-f context database 202 that stores N32-f context information for remote SEPPs with which N32-f security capability exchanges have been successfully completed. Health check message verifier 404 may be implemented using computer executable instructions stored in memory 402 and executed by processor 400.

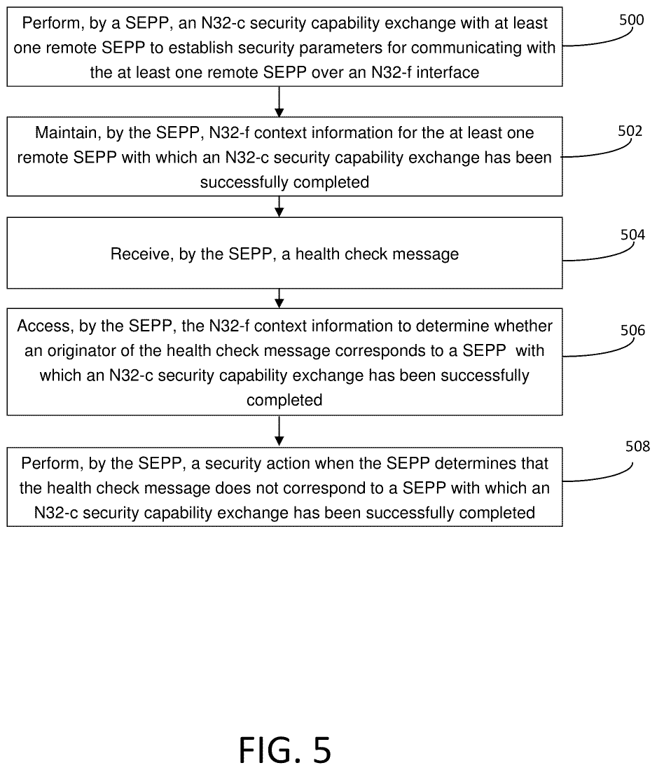

FIG. 5 is a flow chart illustrating an exemplary process for enhanced SEPP firewall filtering for health check messages. Referring to FIG. 5, in step 500, the process includes performing, by a SEPP, an N32-c security capability exchange with at least one remote SEPP to establish security parameters for communicating with the at least one remote SEPP over an N32-f interface. For example, a SEPP, such as SEPP 126B, may perform N32-c security capability handshake procedures with at least one remote SEPP. SEPP 126B may be the initiating or responding SEPP in the N32-c security capability exchanges.

In step 502, the process includes maintaining, by the SEPP, N32-f context information for the at least one remote SEPP with which an N32-c security capability exchange has been successfully completed. For example, a SEPP, such as SEPP 126B, may store remote SEPP identification information, including an FQDN, of each remote SEPP with which an N32-c security capability exchange has been successfully completed. SEPP 126B may store the N32-f context information in N32-f context database 202.

In step 504, the process includes receiving, by the SEPP, a health check message. For example, a SEPP, such as SEPP 126B, may receive a health check request message from another network entity, which may be another SEPP or a malicious network entity impersonating a SEPP. The health check request message may be a packet internet groper (PING) message other message type that can be used to verify the reachability and operational status of a remote entity.

In step 506, the process includes accessing, by the SEPP, the N32-f context information to determine whether an originator of the health check message corresponds to a SEPP with which an N32-c security capability exchange has been successfully completed. For example, a SEPP, such as SEPP 126B, may read, from the health check request message, an FQDN from a subject alternative name field of a TLS certificate transmitted with the health check request message and use the FQDN to perform a lookup in N32-f context database 202 for a record corresponding to the FQDN obtained from the health check request message.

In step 508, the process includes performing, by the SEPP, a security action when the SEPP determines that the health check message does not correspond to a SEPP with which an N32-c security capability exchange has been successfully completed. For example, a SEPP, such as SEPP 126B, may perform a network security action when SEPP 126B determines that the FQDN obtained from a health check request message is not present in a record in N32-f context database 202 corresponding to a remote SEPP with which an N32-c security capability exchange has been successfully completed. The network security action may include discarding the health check request message and/or transmitting a message to a network operator informing network operator of the health check request message transmitted by a malicious entity.

If, in step 508, the SEPP determines that the FQDN read from the SAN field of the TLS certificate carried with the health check request message matches an FQDN in a record in N32-f context database 202 for a remote SEPP with which an N32-c security capability exchange has been successfully completed, SEPP 126B may process the health check request message, generate a health check response message, and transmit the health check response message to the originator of the health check request message.

Exemplary advantages of the subject matter described herein include providing enhanced security. Only authenticated health check messages are processed, reducing the risk of unauthorized access. Another advantage of the subject matter described herein includes providing robust protection against man-in-the-middle (MITM) attacks by validating the authenticity of remote SEPPs. Yet another advantage of the subject matter described herein includes protecting SEPP microservices and backend services from message flooding attacks due to a flood of health check request message. Yet another advantage of the subject matter described herein includes maintaining the integrity of SEPP communications over the N32-f interface by ensuring that health check messages come from verified sources. Yet another advantage of the subject matter described herein includes addressing a critical network security issue by closing potential loopholes that could be exploited for attacks. Yet another advantage of the subject matter describe herein is that the methodology aligns with best practices and standards for secure communications, ensuring compliance with industry regulations. Yet another advantage of the subject matter described herein includes enhancing trust and reliability in the SEPP framework, fostering confidence among stakeholders.

The disclosure of each of the following references is hereby incorporated herein by reference in its entirety.

### REFERENCES

1. 3^{rd} Generation Partnership Project; Technical Specification Group Core Network and Terminals; 5G System; Network Function Repository Services; Stage 3 (Release 19) 3GPP TS 29.510 V19.0.0 (2024-09)
2. 3^{rd} Generation Partnership Project; Technical Specification Group Core Network and Terminals; 5G System; Public Land Mobile Network (PLMN) Interconnection; Stage 3 (Release 19) 3GPP TS 29.573 V 19.0.0 (2024-09)
3. 3^{rd} Generation Partnership Project; Technical Specification Group Services and System Aspects; System Architecture for the 5G System (5GS); Stage 2 (Release 19) 3GPP TS 23.501 V 19.1.0 (2024-09)
4. 3^{rd} Generation Partnership Project; Technical Specification Group Services and System Aspects; Procedures for the 5G System (5GS); Stage 2 (Release 19) 3GPP TS 23.502 V 19.1.0 (2024-09)
5. 3^{rd} Generation Partnership Project; Technical Specification Group Core Network and Terminals; 5G System; Technical Realization of Service Based Architecture; Stage 3 (Release 19) 3GPP TS 29.500 V 19.0.0 (2024-09)
6. 3^{rd} Generation Partnership Project; Technical Specification Group Core Network and Terminals; Numbering, addressing and identification; (Release 19) 3GPP TS 23.003 V 19.0.0 (2024-09)
7. 3^{rd} Generation Partnership Project; Technical Specification Services and System Aspects; Security Architecture and Procedures for 5G System (Release 19) 3GPP TS 33.501 V 19.0.0 (2024-09)
8. GSMA; 5G Interconnect Security; GSMA FS. 36; Version 2.2 (26 Oct. 2022)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for enhanced security edge protection proxy (SEPP) firewall filtering for health check messages, the method comprising:
performing, by a SEPP, an N32-c security capability exchange with at least one remote SEPP to establish security parameters for communicating with the at least one remote SEPP over an N32-f interface;
maintaining, by the SEPP, N32-f context information for the at least one remote SEPP with which an N32-c security capability exchange has been successfully completed;
receiving, by the SEPP, a health check message;
accessing, by the SEPP, the N32-f context information to determine whether an originator of the health check message corresponds to a SEPP with which an N32-c security capability exchange has been successfully completed; and
performing, by the SEPP, a network security action when the SEPP determines that the health check message does not correspond to a SEPP with which an N32-c security capability exchange has been successfully completed.

2. The method of claim 1 wherein performing the N32-c security capability exchange includes obtaining a fully qualified domain name (FQDN) of the at least one remote SEPP.

3. The method of claim 2 wherein storing the N32-f context information includes storing the FQDN of the at least one remote SEPP in an N32-f context database maintained by the SEPP.

4. The method of claim 1 wherein receiving a health check message includes receiving a health check message including a transport layer security (TLS) certificate.

5. The method of claim 4 wherein accessing the N32-f context information includes accessing the N32-f context information using sender identification information obtained from the TLS certificate.

6. The method of claim 5 wherein accessing the N32-f context information using the sender identification information obtained from the TLS certificate includes accessing the N32-f context information using a fully qualified domain name (FQDN) obtained from a subject alternative name (SAN) field of the TLS certificate.

7. The method of claim 6 wherein performing the network security action includes performing the network security action when the FQDN obtained from the SAN field of the TLS certificate does not match an FQDN of a remote SEPP with which an N32-c security capability exchange has been successfully completed.

8. The method of claim 1 comprising, when the SEPP determines that the health check message corresponds to a remote SEPP with which an N32-c security capability exchange has been successfully completed, responding to the health check message.

9. The method of claim 1 wherein performing the network security action includes discarding the health check message.

10. The method of claim 1 wherein performing the network security action includes alerting a network operator of receipt of a health check message from a suspicious network entity.

11. A system for enhanced security edge protection proxy (SEPP) firewall filtering for health check messages, the system comprising:
a SEPP including at least one processor and a memory for performing an N32-c security capability exchange with at least one remote SEPP to establish security parameters for communicating with the at least one remote SEPP over an N32-f interface and maintaining N32-f context information for the at least one remote SEPP with which an N32-c security capability exchange has been successfully completed; and
a health check message verifier implemented by the at least one processor for receiving a health check message, accessing the N32-f context information to determine whether an originator of the health check message corresponds to a SEPP with which an N32-c security capability exchange has been successfully completed, and performing a network security action when the health check message verifier determines that the health check message does not correspond to a SEPP with which an N32-c security capability exchange has been successfully completed.

12. The system of claim 11 wherein the SEPP is configured to obtain, while performing the N32-c security capability exchange, a fully qualified domain name (FQDN) of the at least one remote SEPP.

13. The system of claim 12 wherein the SEPP is configured to store the FQDN of the at least one remote SEPP in an N32-f context database maintained by the SEPP.

14. The system of claim 11 wherein the health check message includes a transport layer security (TLS) certificate.

15. The system of claim 14 wherein the health check message verifier is configured to access the N32-f context information using sender identification information obtained from the TLS certificate.

16. The system of claim 15 wherein the sender identification information includes a fully qualified domain name (FQDN) obtained from a subject alternative name (SAN) field of the TLS certificate.

17. The system of claim 16 wherein the health check message verifier is configured to perform the network security action when the FQDN obtained from the SAN field of the TLS certificate does not match an FQDN of a remote SEPP with which an N32-c security capability exchange has been successfully completed.

18. The system of claim 11 wherein the health check message verifier is configured to, when the health check message verifier determines that the health check message corresponds to a remote SEPP with which an N32-c security capability exchange has been successfully completed, respond to the health check message.

19. The system of claim 11 wherein the network security action includes discarding the health check message or alerting a network operator of receipt of a health check message from a suspicious network entity.

20. A non-transitory computer readable medium having stored thereon executable instructions that when executed by a processor of a computer control the computer to perform steps comprising:
performing, by a security edge protection proxy (SEPP), an N32-c security capability exchange with at least one remote SEPP to establish security parameters for communicating with the at least one remote SEPP over an N32-f interface;
maintaining, by the SEPP, N32-f context information for the at least one remote SEPP with which an N32-c security capability exchange has been successfully completed;
receiving, by the SEPP, a health check message;
accessing, by the SEPP, the N32-f context information to determine whether an originator of the health check message corresponds to a SEPP with which an N32-c security capability exchange has been successfully completed; and
performing, by the SEPP, a network security action when the SEPP determines that the health check message does not correspond to a SEPP with which an N32-c security capability exchange has been successfully completed.
